(19) United States
(12) Patent Application Publication
(10) Pub. No.: US 2006/0289465 A1
(43) Pub. Date: Dec. 28, 2006

(54) Control for a domestic appliance and display of information

(75) Inventors: Katja Balk, Grabenstatt (DE); Manfred Plankl, Traunreut (DE); Hans Rogenhofer, Holzkirchen (DE); Michael Ulmer, Traunreut (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate Gmbh, Munich (DE)

(21) Appl. No.: 10/571,164

(22) PCT Filed: Sep. 13, 2004
(86) PCT No.: PCT/EP04/10223

§ 371 Date: Mar. 6, 2006

(30) Foreign Application Priority Data
Sep. 12, 2003 (DE) 10342321.4

(51) Int. Cl. H05B 1/02

(52) U.S. Cl. 219/506

(57) ABSTRACT

A control and a method for controlling a domestic appliance, especially a cooking device, including a display unit for displaying information, the control controlling the display of information on the display unit. The control includes a separate input element for retrieving information so that the user can retrieve the information by actuating the separate input element and the information is then displayed on the display unit. Particularly, the information can be retrieved from different operating states of the domestic appliance.

The present invention relates to a control for a household appliance, especially a cooking device, comprising a display unit for displaying information, said control controlling the display of information, and a corresponding method for controlling a household appliance, especially a cooking device.

Such a control is known from DE 198 32 757 C2. Described there is a control comprising a control unit configured with a graphical display device, a plurality of functional control elements and a plurality of input control elements. Associated with each of the control elements is a display panel of the display device which is fixed or variable in its arrangement and extension. The functional allocation for each of the control elements is variable and is controlled by the control system. The actual functional allocation of the control elements is indicated by a corresponding designation on the respectively allocated control panel. Thus, a function menu is displayed to the user from which he can select an allocated menu item by actuating one of the control elements. An information menu item is provided for one of the functional allocations so that by actuating the relevant control element, the user can retrieve information which is then displayed on the display device.

The disadvantage of the control proposed in DE 198 32 757 C2 is that the number of menu items is limited by the number of display panels or by the number of control elements and that the control element for retrieving the information is allocated to the display device. Thus, it depends on the actual functional allocation whether the information menu item is available to the user or not. That is, the user can only retrieve information if the information menu item is allocated to one of the control elements in the actual functional allocation.

It is the object of the invention to provide a user-friendly control for a domestic appliance, especially a cooking device, which is simple to handle.

The object is solved by a control for a domestic appliance, especially a cooking device, with the features of claim 1 and a method for controlling a domestic appliance, especially a cooking device, with the features of claim 11.

The control comprises a separate input element for retrieving information so that a user can retrieve information by actuating the separate input element and the information is then displayed on the display unit. In particular, the information can be retrieved from different operating states of the domestic appliance, especially the cooking device.

Thus, during the various operating states of the domestic appliance, especially the cooking device, information is available to the user which he can retrieve simply by actuating the separate input element. In addition, different information can be displayed by the control system depending on the respective operating state. This has the advantage that situation-related information is available to the user, thereby facilitating usage of the cooking device.

According to a preferred embodiment, it is provided that the information is in the form of menu items of an information menu and that the control system has a selection device for browsing through the menu items so that the user can browse through the menu items using the selection device. The selection device advantageously corresponds to the input element. Thus, a plurality of information can be made available to the user which can be simply retrieved by the user by multiple actuation of the input element.

In order to keep the input effort for the user low, in a preferred embodiment it is provided that the information menu is automatically exited by the control system for at least one of the menu items after a predetermined time interval has elapsed. In this way, if the user has obtained the information that he desires, he does not need to make any further input. The information menu is automatically exited after the predetermined time interval has elapsed and the display device returns to the same state as before the retrieval of the information.

According to a preferred embodiment, it is provided that after browsing through all the menu items by the control system, the information menu is exited by actuating the input element. In this way, the user is notified that no further information is available on the actual operating state.

In particular, state parameters of the cooking device and/or explanations of the appliance functions and/or usage instructions are displayed by the control system as information. In this way, for example, the user can be informed of the actual temperature during heating up of the cooking device or of the residual heat after the end of a cooking process. In particular, the operating modes used, such as overheat or underheat for example can be explained for the user. Furthermore, information on a cookware to be used or on an optimal insertion height in a baking oven can be given.

Advantageously information can be retrieved from every operating state of the cooking device. Thus, information is available to the user at any time.

In particular, the invention relates to a cooking device, such as a cooker with a baking oven, a microwave or a light wave oven.

The invention and its further developments are explained in detail hereinafter with reference to drawings:

In the figures

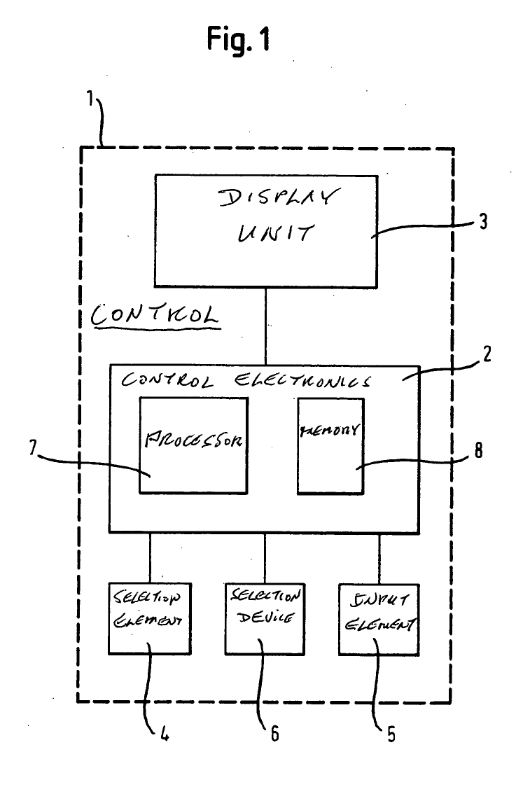

FIG. 1 is a schematic diagram of a control according to the invention for a cooking device; and

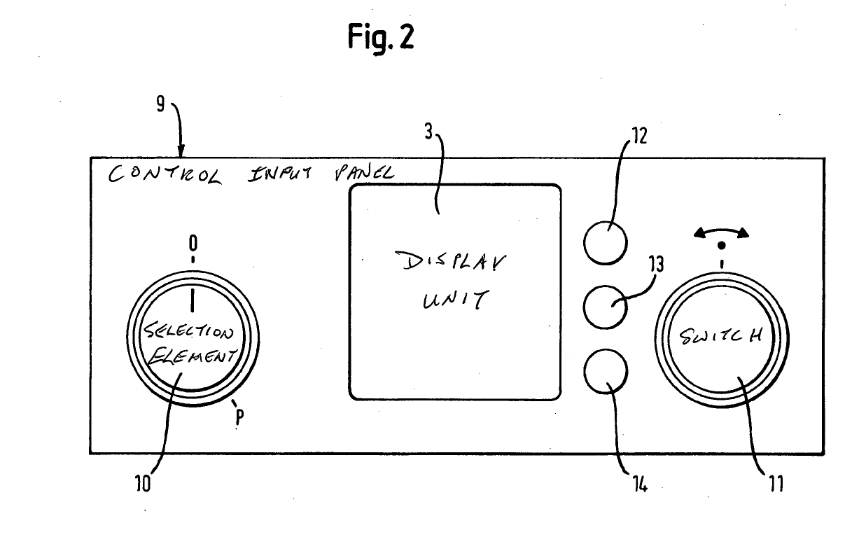

FIG. 2 is an input panel for the control of the cooking device.

A control 1 according to the invention shown in FIG. 1 for a cooking device comprises control electronics 2 connected to a display unit 3, a selection element 4 for selecting a cooking program or an operating mode, a separate input element 5 for retrieving information or a selection device 6 for browsing through menu items. The control electronics 2 also has connections to the actuators of the cooking device, such as for example various heating elements or a fan and connections to further input elements or sensors which are not shown here. The control electronics 2 comprises a processor unit 7 and memory unit 8.

FIG. 2 shows an input panel 9 for the control 1 of the cooking device, comprising the display unit 3, a selection element 10 for activating an automatic program selection or for selecting an operating mode, a rotary switch 11 comprising a bit generator, a start button 12 for starting a cooking process, a confirmatory element 13 for confirming a program selection and an information button 14 for retrieving information.

Using the selection element a user selects an operating mode, e.g. overheat or underheat or sets the selection element 10 to the switch position P and thus activates the automatic program selection. Using the rotary switch 11 which can be turned in either direction according to the directions of the arrow in FIG. 2, the user selects a cooking program for a dish, the description of the respective dish being indicated on the display unit 3. The cooking program is selected by actuating the actuation element 13. The cooking process is started by actuating the start button 12.

By actuating the information button 14, the user can retrieve information at any time and this is displayed on the display unit 3. For example, in the heating-up phase of the cooking device a current actual temperature of the cooking device determined using a temperature sensor is displayed by actuating the information button 14. After the end of the cooking process, the residual heat of the cooking device can be retrieved by the user in the same way. That is, by actuating the information button 14, it is possible for the user to retrieve current state parameters of the cooking device which are determined by sensors, for example, or in another way.

Furthermore, when selecting an automatic cooking program, for example, the user can retrieve information on the respective cooking program using the information button 14, such as for example, information on cookware to be used or on an optimal insertion height of a baking tray in a baking oven. Information on a selected operating mode can also be retrieved, such as for example in the case of over/underheat, the indication of traditional baking or roasting. For appliance functions usage instructions or explanations can be retrieved such as, for example, in the case of a cooking time function the instruction that the cooking process will be ended after the set cooking time has elapsed. This information is typically stored in the memory unit 8 and is retrieved in a situation-related fashion via the processor unit 7 after actuating the information button 14 and is displayed on the display unit 3.

The information is available in the form of an information menu. After actuating the information button 14, the user can browse through the menu items of the information menu by using the rotary switch 11. Instead of the rotary switch 11, in an alternative possibility the menu items can be browsed through by multiple actuation of the information button 14. In this case, the selection device 6 then corresponds to the input element 5, namely the information button 14. If the selection device 6 is not actuated for a predetermined time interval at one of the menu items of the information menu, the information menu is automatically exited and the display device 3 returns to the state before actuating the information button 14. The information menu is also exited if all the available menu items have been browsed through and the selection device 6 is actuated once more.

### REFERENCE LIST

1 Control
2 Control electronics
3 Display device
4 Selection device for selecting a cooking program or an operating mode
5 Separate input element for retrieving information
6 Selection device for browsing through menu items
7 Processor unit
8 Memory unit
9 Input panel
10 Selection element
11 Rotary switch with bit generator
12 Start button
13 Actuation element
14 Information button

1-19. (canceled)

20. A control for a domestic cooking appliance, comprising:
a display unit for displaying information;
the control controls the display of said information; and
said control includes a separate input element for retrieving said information.

21. The control according to claim 20, including said information can be retrieved from various operating states of the domestic appliance.

22. The control according to claim 21, including said control displays different information depending on the respective operating state of said domestic appliance.

23. The control according to claim 20, including said information is available in the form of menu items of an information menu and said control includes a selection device for browsing through said menu items.

24. The control according to claim 23, including said selection device corresponds to said input element.

25. The control according to claim 24, including said control for at least one of said menu items automatically at least one of exits or ends said information menu after a predetermined time interval has elapsed.

26. The control according to claim 25, including after browsing through all of said menu items, said control automatically exits said information menu by actuating said input element.

27. The control according to claim 20, including said control displays at least one of state parameters or explanations of functions or usage instructions of the domestic appliance.

28. The control according to claim 20, including said information can be retrieved from substantially every one of the operating states of said domestic appliance.

29. A domestic cooking appliance, comprising:
a control including;
a display unit for displaying information;
said control controls the display of said information; and
said control includes a separate input element for retrieving said information.

30. The cooking appliance according to claim 29, including said information can be retrieved from various operating states of the domestic appliance.

31. The cooking appliance according to claim 20, including said control displays different information depending on the respective operating state of said domestic appliance.

32. The cooking appliance according to claim 20, including said information is available in the form of menu items of an information menu and said control includes a selection device for browsing through said menu items.

33. The cooking appliance according to claim 32, including said selection device corresponds to said input element.

34. The cooking appliance according to claim-33, including said control for at least one of said menu items automatically at least one of exits or ends said information menu after a predetermined time interval has elapsed.

35. The cooking appliance according to claim 34, including after browsing through all of said menu items, said control automatically exits said information menu by actuating said input element.

36. The cooking appliance according to claim 29, including said control displays at least one of state parameters or explanations of functions or usage instructions of the domestic appliance.

37. The cooking appliance according to claim 29, including said information can be retrieved from substantially every one of the operating states of said domestic appliance.

38. A method for controlling a domestic cooking appliance, comprising:
including a display device having at least one separate input element;
retrieving information of the domestic appliance;
displaying said information on said display device by actuating said separate input element.

39. The method according to claim 38, including retrieving said information from different operating states of said domestic appliance.

40. The method according to claim 39, including displaying different information depending on the respective one of said operating states.

41. The method according to claim 38, including forming said available information in the form of menu items of an information menu and browsing said menu items by using a selection device of said display device.

42. The method according to claim 41, including browsing said menu items by using said separate input element.

43. The method according to claim 41, automatically exiting said information menu for at least one of said menu items after a predetermined time interval has elapsed.

44. The method according to claim 41, exiting said information menu after browsing through all said menu items by actuating said separate input element.

45. The method according to claim 38, including displaying as information at least one of the state parameters or explanations or usage instructions of said domestic appliance.

46. The method according to claim 38, including retrieving information from substantially each operating state of said domestic appliance.
